(19) United States
(12) Patent Application Publication
(10) Pub. No.: US 2011/0214502 A1
(43) Pub. Date: Sep. 8, 2011

(54) LEVEL

(76) Inventor: Jingdong Zhang, Berkshire (GB)

(21) Appl. No.: 13/128,942

(22) PCT Filed: Dec. 4, 2009
(86) PCT No.: PCT/GB09/02833

§ 371 Date: May 12, 2011

(30) Foreign Application Priority Data
Dec. 6, 2008 (GB) 0822283.8

(51) Int. Cl. G01F 23/284

(52) U.S. Cl. 73/290 V

(57) ABSTRACT

The present invention provides a level sensor, preferably a level switch, which in use is mounted at the position at which a fluid level is to be monitored and uses a relatively low resolution TDR circuit to discriminate only between wet and dry states.

### FIELD OF THE INVENTION

This invention relates to level sensors.

### BACKGROUND TO THE INVENTION

There is an ongoing demand for apparatus capable of indicating the level of the contents in a tank. These fall into two essential groups. The first group covers apparatus capable of indicating level on a continuous basis. This includes apparatus which cause a pulse of ultrasound or radar to be transmitted from above the level of the contents, towards the contents, and then analyses the reflected pulse from the surface of the contents to determine to the distance of the level from the transmitter. This first group further includes devices operating according to the Time Domain Reflectometry (TDR) principle where an electromagnetic pulse is propagated along a waveguide extending down into the tank, and below the level of the tank contents. At the position at which the waveguide, generally in the form of a steel rod or cable, enters the contents, part of the pulse energy is reflected back along the waveguide. This reflected pulse from the surface of the contents can be analysed to determine the level of the contents.

Continuous level measurement involves relatively complex and potentially expensive electronic hardware to ensure measurement accuracy.

A second group comprises devices known as level switches. These only indicate predefined fluid levels of tank contents. This group includes floats which float on the surface of the contents and provide a signal to operate a cut-off valve when the contents rise to, or fall from, a defined level. Other devices in this group include vibrating fork devices which are caused to vibrate at their natural vibrating frequency. This operating frequency is monitored and, when it drops due to the forks coming into contact with a liquid when the liquid level is rising, or rises due to the forks becoming uncovered as the liquid level falls, the content's level is known.

Vibrating fork devices are widely used and, for the most part, are inexpensive and reliable. However they have limitations, the most significant one being that the use of these devices is confined to environments operating at temperatures below about 250° C. At temperatures above 250° C. the piezo electric crystals employed to impart vibration to the forks typically sustain damage. A further problem can arise with the manufacture of vibrating fork devices which need to include a long extension tube so that the fork assembly can be correctly located in relation to the fluid to be monitored. The manufacture of devices with long extension tubes is difficult because small imbalances introduced into the fork structure, during manufacture, will reduce the detection sensitivity significantly. Finally, the piezo-electric crystals typically contain lead and are thus not considered to be environmentally friendly.

It is an object of this invention to provide a method and/or apparatus which addresses at least some of the drawbacks mentioned above, or which will at least offer a novel and useful choice.

### SUMMARY OF THE INVENTION

Accordingly, in one aspect, the invention provides a method of determining when an interface between a first fluid of a first permittivity and a second fluid of a second permittivity is at a defined level, said method comprising: providing an electromagnetic transmission line having an outer end; causing an electromagnetic pulse to be propagated along and reflected back along said transmission line by a time domain reflectometry (TDR) technique; and detecting an interval between an initial time reference and the time of receipt of a reflected pulse, said method being characterized in that in includes:

mounting said transmission line at said defined level; and

assessing only whether said transmission line is in said first fluid or said second fluid from an observation of a time interval between said initial time reference and receipt of a pulse reflected from said outer end.

Preferably said transmission line extends from a housing, said method further including establishing said initial reference time by causing a step change of impedance of said transmission line within said housing or within a connector fixed to said housing.

The method herein defined is particularly suited to applications which require the transmission line to be mounted on an extension tube.

Said method may be applied to the determination of a level of liquid having air or another gas there-above. Said method may also be applied to the determination of a level of flowable solids such as pellets and powders, with air or another gas there-above. Still further, the method may be applied to the determination of a level of an interface between two liquids of different permittivity.

Said method may be applied to the determination of a level of a conductive liquid wherein the step of assessing whether said transmission line is in said conductive fluid includes the step of looking for a positive reflection signal generated by the liquid shorting said transmission line.

In a second aspect the invention provides a level sensor operable to determine when an interface between a first fluid of a first permittivity and a second fluid of a second permittivity is at a defined level, said sensor including an electromagnetic transmission line having an outer end; an electromagnetic pulse generator operable to cause an electromagnetic pulse to be propagated along and reflected back along said transmission line by a time domain reflectometry (TDR) technique; and a detection facility operable to detect a time interval between an initial time reference and the time of receipt of a reflected pulse, said sensor being characterized in that:

in use, said transmission line is mounted at said defined level; and said detection facility is operable to assess only whether said transmission line is in said first fluid or in said second fluid from an observation of a time interval between said initial time reference and receipt of a pulse reflected from said outer end.

Preferably said sensor includes an impedance step-change to generate said initial time reference. This step-change may be defined within a housing forming part of the sensor or within a connector fixed to said housing.

Preferably said transmission line is defined by the tines of a fork assembly.

Preferably said fork assembly includes two tines.

Alternatively said fork assembly includes three tines. Said tines, whether two or three in number, may be coated in a thin plastics layer.

Preferably at least one of said tines includes insulation about a root thereof.

Preferably said transmission line extends from a body. Preferably said body is formed from stainless steel.

Preferably said transmission line is located within said body by plastics or ceramic insulating material. More preferably said insulating material comprises PEEK.

Preferably one or more seals are provided between said insulating material and said body.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future.

### BRIEF DESCRIPTION OF THE DRAWINGS

Embodiments of the invention will now be described with reference to the accompanying drawings in which:

FIG. 1: shows a typical installation of a level sensor according to the invention;

FIG. 2: shows a cross-section through a first embodiment of level sensor according to the invention;

FIG. 3: shows an operating circuit block diagram for the sensor shown in FIG. 2;

FIG. 4: shows a signal trace of the sensor shown in FIG. 2, operating in air;

FIG. 5: shows a signal trace of the sensor shown in FIG. 2, operating in water;

FIG. 6: shows a signal trace of the sensor shown in FIG. 2, operating in vegetable oil;

FIG. 7: shows a cross-section through a second embodiment of level sensor according to the invention;

FIG. 8: shows a signal trace of the sensor shown in FIG. 7, operating in air;

FIG. 9: shows a signal trace of the sensor shown in FIG. 7, operating in water;

FIG. 10: shows a signal trace of the sensor shown in FIG. 7, operating in vegetable oil; and

FIG. 11: is a diagram illustrating a technique for establishing a threshold used in the invention.

### DESCRIPTION OF WORKING EMBODIMENT

The invention provides a method of and/or apparatus for determining the presence of a fluid interface at a defined level. In this context ‘fluids’ should be regarded in their broadest interpretation and may comprise a gas/liquid interface, and gas/fluidized solids interface and/or a liquid/liquid interface.

The invention performs the same general function as a conventional tuning fork level detector. In this case, however, instead of a vibrating fork being mounted at the level to be detected, an electromagnetic transmission line is mounted. In use, an electromagnetic pulse is propagated along and reflected back along the transmission line by a time domain reflectometry (TDR) technique, the time interval between the emitted pulse and reflected pulse being detected. However, unlike a conventional TDR level measuring device, we are only interested in reflections from the end of the transmission line and, accordingly, the time interval is analysed only to the extent of determining in which of the fluids bordering the interface, the transmission line is in contact. Thus, the high accuracy and high cost electronic hardware, normally associated with TDR level measurement, can be avoided.

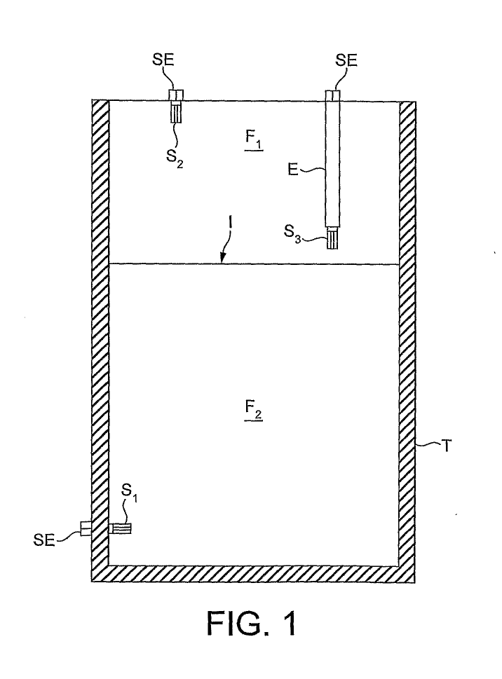

Referring to FIG. 1, as with a conventional vibrating fork level sensor the electromagnetic transmission line level sensor may be mounted in a number of different ways on a tank T so as to monitor the level of interface I between a first fluid F₁ and a second fluid F₂. Thus sensor S₁ is mounted horizontally on a lower part of the tank wall so as to detect a lower position of the interface I. Sensor S₂ is mounted vertically from the upper edge or lid of the tank to detect an upper position of the interface I. Sensor S₃ is also mounted vertically but on the lower end of an extension tube E to, again, detect an upper position of the interface I, albeit at a position which is lower than that detected by sensor S₂. A sensor according to the invention is particularly suited for use in conjunction with an extension tube as, when compared with a vibrating fork mounted on an extension tube, there is no loss of detection sensitivity due to fork imbalance.

As will be described in greater detail below, the invention relies on fluids F₁ and F₂ being of different permittivities and the sensors S₁, S₂ or S₃, having sensor electronics SE, responding only when the level L of the fluid F₂ rises into contact with, or falls below, the level of the sensor. When the sensor changes in state between wet and dry this is detected by the sensor electronics SE and an appropriate signal, such as an alarm or a switching signal, is generated.

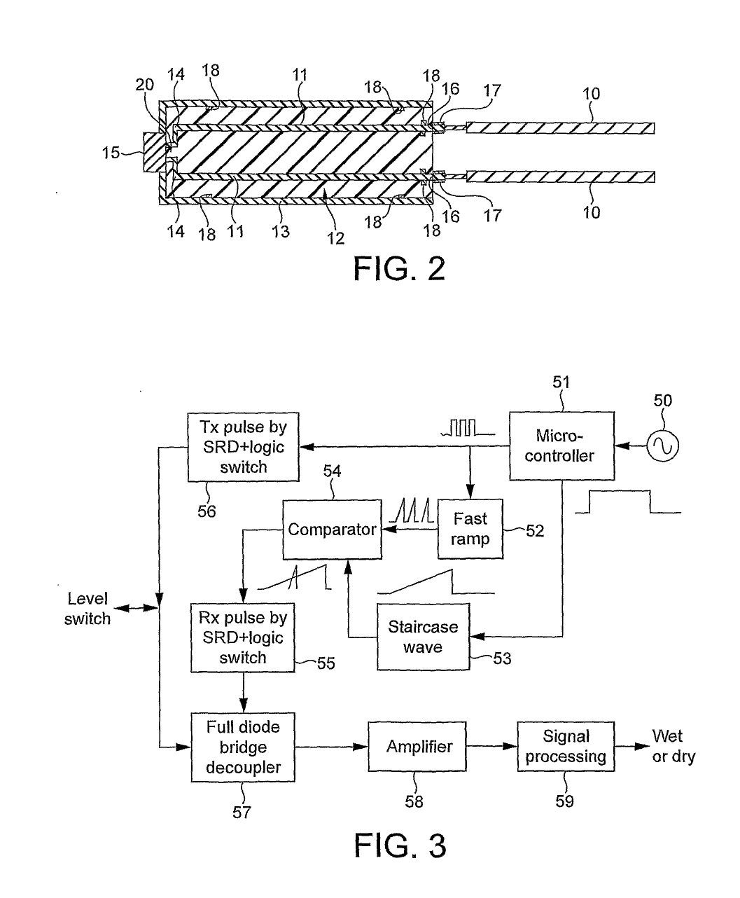

As can be seen from FIG. 2, the transmission line level sensor is defined by a fork assembly having a pair of tines 10. The tines 10 extend from a pair of pair of rods 11 encased in a body of insulating material 12 retained in an outer housing or body 13. The inner ends 14 of the rods 11 are connected to a TDR circuit at 15. The roots 16 of the tines (where the tines 10 enter the insulating material and connect to the rods 11) may be surrounded by insulating coatings or sleeves 17. This prevents any water condensation shorting the two tines when the sensor is in use.

The tines are preferably formed from stainless steel and could be coated with a thin layer of plastics material such as TEFLON. The shape of the tines, and the spacing between the tines, are designed to ensure a high sensitivity to the medium in contact with the tines, and to maintain a substantially constant impedance along the length of the tines. The insulating material 12 is preferably polyetheretherketone (PEEK) whilst the outer housing 13 is conveniently formed from stainless steel. It will be appreciated, however, that alternative materials could be used including (but not limited to) ceramics for the insulating material and other steels and alloys for the housing 13.

Seals such as o-rings 18 may be provided between the insulating material 12 and the inner surface of the outer housing 13, and between the insulating material 12 and the rods 11; although alternative forms of sealing will be readily apparent to those skilled in the art.

To operate according to the TDR principle in a cost-effective manner, an initial time reference must be generated. In the form shown this is achieved by the impedance step-change at 20. This step change 20 should be positioned at about 20 to 100 mm from the tine roots 16. As an alternative to the step-change 20, the diameter and/or spacing of the rods 11 could be modified; a different insulation could be used in the vicinity of the inner ends 14 of the rods; or the connector 15 could be designed to generate the required impedance.

The use of short, thin rods 11, and the change in diameter where the tines 10 attach to the rods 11, ensure that the impedance mismatch at the time roots 16 is minimized. This, in turn, reduces the interference in the reference and reflected (or detection) signals.

As described above the TDR facility embodied in the present invention is configured solely to determine if the tines 11 are wet or dry.

The time difference between wet and dry conditions may be calculated by the formula:

δt=2*L*(εᵣ−1)/(con*cₒ)

where:
L is the length of the tines
εᵣ is the relative dielectric constant of the fluid
cₒ is the speed of light in vacuum
con is a constant slightly less than 1 and dependent on the type of transmission line

It will be appreciated that, if we suppose con is equal to 1, this will give a minimum or worst case calculation of the time difference.

Table 1 shows the minimum time differences observed for different fork lengths and media having differing dielectric constants. Given that existing commercial TDR level measurement devices are capable of accurately measuring time differences down to 5 ps, the feasibility of using the TDR principle to merely establish a wet or dry condition, is evident.

The ability of a sensor according to the invention to operate with a medium having a low dielectric constant will depend on the length of the tines and the quality of the TDR circuit. However, if we assume a threshold for the time difference as being 100 ps, and allow for some margin around this as will be described in greater detail below, it can be seen from Table 1 that a sensor having tines of 60 mm in length will be capable of detecting a wet or dry condition of a medium having a minimum dielectric constant of 1.75. This includes a large number of industrial fluid media.

TABLE 1

| Fork | Minimum time | Minimum time | Minimum time | Minimum time |
|---|---|---|---|---|
| length | difference (ps) | difference (ps) | difference (ps) | difference (ps) |
| (mm) | for ∈ᵣ = 1.5 | for ∈ᵣ = 1.75 | for ∈ᵣ = 2.0 | for ∈ᵣ = 2.5 |
| 50 | 75 | 108 | 138 | 194 |
| 60 | 90 | 129 | 166 | 232 |
| 70 | 105 | 151 | 193 | 271 |

A TDR electronics circuit suitable for use in the invention could be implemented in a number of different ways, one of which is shown in FIG. 3. In particular the proposed approach renders unnecessary the precision sampling circuit of the type described in U.S. Pat. No. 5,345,471 (McEwan).

Referring to FIG. 3, an oscillator 50 generates the time reference which is fed to microcontroller 51 to effect equivalent time sampling. The technique proposed herein is the dual ramping technique described in U.S. Pat. No. 3,010,071 (Carlson). The microcontroller 51 generates two control pulses, a short interval pulse and a long interval pulse. The short interval pulse is fed to a fast ramp generator 52 which produces a short, steep waveform whilst the long interval pulse is fed to a slow ramp generator 53 which produces a staircase waveform. The two wave forms are fed to a comparator 54 which controls the function of the delayed receiving gate 55. The receiving gate 55 generates the receiving pulse using a combination of step recovery diodes and a fast logic switch.

The microcontroller 51 also provides a short interval pulse to transmit pulse generator 56 which, as with the receive pulse generator 55, generates the transmit pulse using a combination of step recovery diodes and a fast logic switch.

Transmit and receive signals are both applied to a full diode bridge decoupler 57 which generates a signal representing the time interval between the reference signal and the reflected signal. The full diode bridge decoupler is described in greater detail in U.S. Pat. No. 3,597,633 (Hirano). The output of the decoupler 57 is amplified at 58 and then subjected to signal processing at 59. In particular the signal processing step involves applying a threshold to the measured time differences to determine if they represent a wet or dry condition.

The threshold time difference or the time difference which represents a change in state between wet and dry, is a pre-defined value dependant on the tine length. For example, the value could be defined by the time interval that half the length of the tine is submerged in fluid with a minimum working permittivity of, say, 1.75. Thus the threshold can be determined by the following:

T_{threshold}=(εᵣ−1)*L/cₒ+Tₒ=0.75*L/cₒ+2*L/cₒ

where:
Tₒ is the time interval in air
εᵣ is the relative dielectric constant of the liquid
L is the tine length
cₒ is the speed of light in a vacuum

Referring to FIG. 11 in practice, in order to make the sensor perform more reliably, a threshold region is preferably established which provides a margin of, say, 20% on either side of the calculated _{T}_{threshold}. Thus the sensor will detect a wet-from-dry status at T₁=T_{threshold} * (1−0.2) whilst a dry-from-wet status will be detected at T₂=T_{threshold} * (1+0.2)

This will prevent the sensor displaying instability when the liquid level is just at the switch point.

Further, εᵣ in the above formula could be adjusted to be nearer to the permittivity of the working medium if it is significantly larger than 1.75.

### EXAMPLE I

Some experiments were conducted on a prototype form of sensor, as described above, having the following dimensions:

diameters of the rods 11: 5 mm,

spacing of rods 11: 10 mm (centre-to-centre).

internal diameter of the housing 13: 20 mm

length of the insulating material 12: 50 mm

tine length: 55 mm (including 10 mm of rod extension)

tine spacing: 10 mm

tine width: variable about 15 mm

The outer housing 13 was formed from stainless steel and the insulating material 12 was formed from PEEK.

The prototype sensor was powered from a prototype TDR circuit similar to that shown in FIG. 3 but with the sequence sampling being achieved by dual oscillators instead of dual ramping. Dual oscillators give better linearity in the longer range so there is no significant difference to the dual ramping technique in shorter ranges.

The master oscillator had a frequency of 3.58 MHz. The frequency difference of the oscillators was 44 Hz giving a time expansion factor of about 81363 and an equivalent pulse repetition rate of about 3 ps.

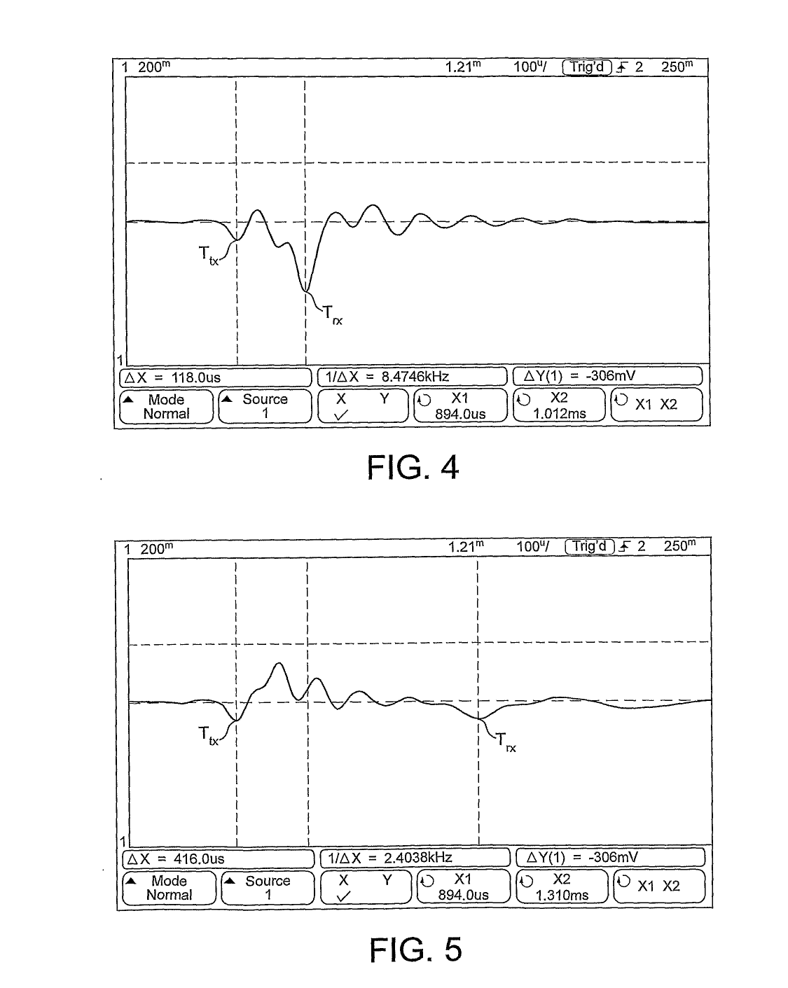

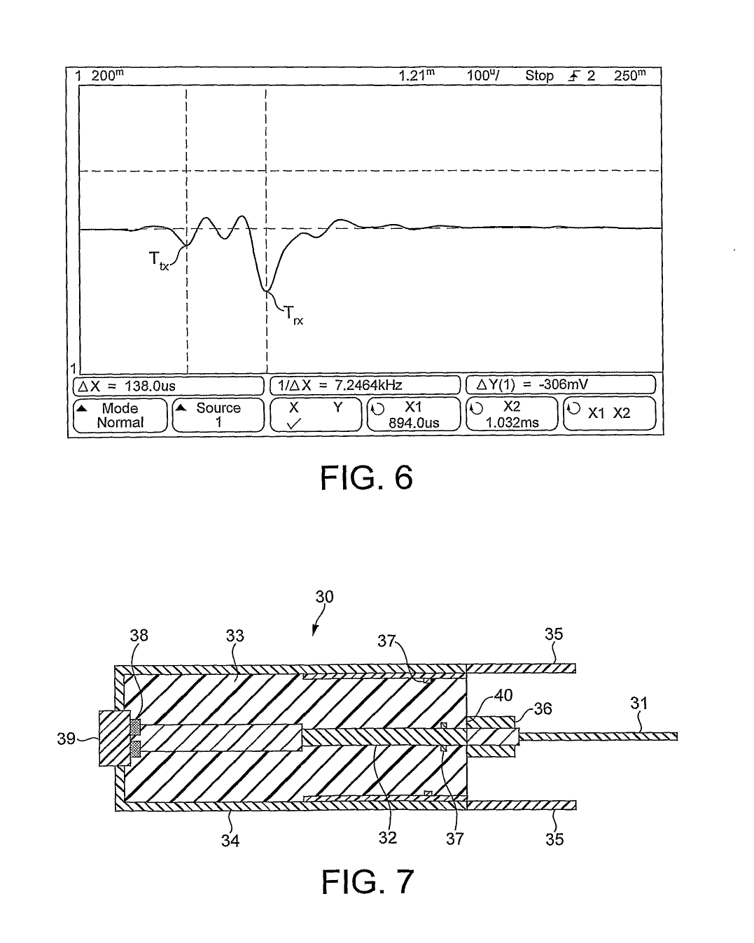

The observed signal traces for air (εᵣ=1), water (εᵣ=˜80) and vegetable oil (εᵣ=˜3) are shown in FIGS. 4,5 & 6 respectively. In each case the position of the reference point is shown at

Tₜₓ while the position of the reflection at the ends of the tines is shown at Tᵣₓ. The time interval in all cases is Tᵣₓ−Tₜₓ.

It will be observed that the time difference (the change in time intervals) in a stretched time base are 20 μs for air/oil and 298 μs for air/water. These readings correspond to 246 ps and 3663 ps respectively, in real time.

Turning now to FIG. 7, a second embodiment 30 of sensor is shown having three tines and based on a co-axial transmission line. As can be seen, a long central tine 31 extends from central rod 32, the rod 32 being located in an insulating block 33 which is preferably formed from PEEK but, as with the example described above, could also be formed from a ceramic. The block 33 is, in turn, firmly located within a stainless steel outer housing 34. Two side tines 35 extend from opposite sides of the housing 34, and extend to opposite sides of the central tine 31.

The root of the centre tine is surrounded with a sleeve or coating 36 to prevent shorting between the side tines and the centre tine. O-rings 37 form seals between the centre rod 32 and the insulation 33, and between the insulation 33 and the outer housing 34. If use in hazardous environments is contemplated, the central tine 31 and the side tines 35 may be coated with a thin layer of plastics material such as TEFLON.

As with the embodiment described above, means must be provided to generate a reference point in the transmitted signal. In the form shown, this is effected by providing a sudden impedance change at the inner end of the central rod 32, at 38. The location of this impedance change is 20 to 100 mm from the root 40 of the central tine 31.

It will be noted that the side tines 35 are shorter than the central tine 31. The longer and wider the side tines 35, the stronger the signal that is reflected from the end of the centre tine 31. However, lengthening and widening the side tines 35 will also increase the likelihood of coating when the sensor is used in environments containing high viscosity liquids. In practice, the length and width of the side tines is chosen to balance the requirements of signal size and reliability. Given that the length of the side tines also affects the size of the reflected signal at the root of the central tine we have found that an effective length for the side tines is between one third and two thirds of the length of the centre tine.

This embodiment of sensor may be driven by the TDR circuit as shown in FIG. 3.

### EXAMPLE II

Some experiments were conducted on a prototype form of sensor, as described above, having the following dimensions:

diameter of the centre rod 32: 5 mm,

length of rod 32: 60 mm

internal diameter of the housing 34: 20 mm

centre tine 31 length: 43 mm

centre tine width: 18 mm

link of tine 31 to rod 32: 10 mm length; 5 mm diameter

side tine length: 33 mm

side tine width: 5 mm

spacing side tines to centre tine: 10 mm

The outer housing 34 was formed from stainless steel and the insulating material 33 was formed from PEEK. The reference point generator was formed by reducing the diameter of the rod 32 to 2 mm and providing a PTFE insulating sleeve of diameter 6.5 mm around the reduced diameter.

The sensor was driven by the same prototype TDR circuit as described in Example I above.

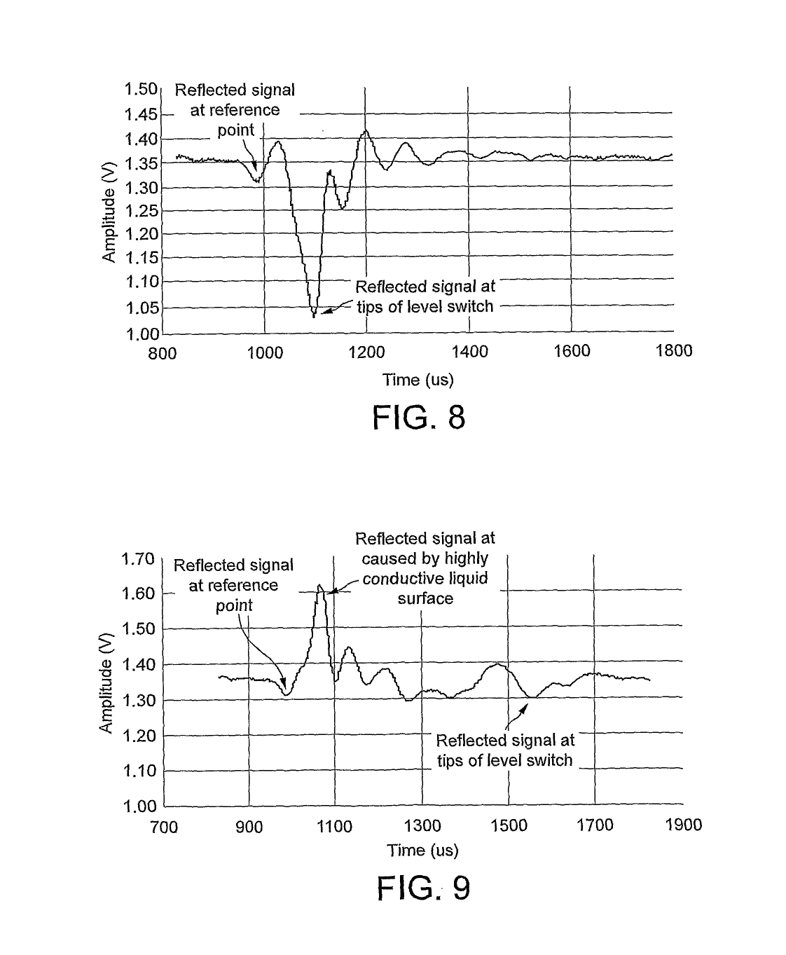

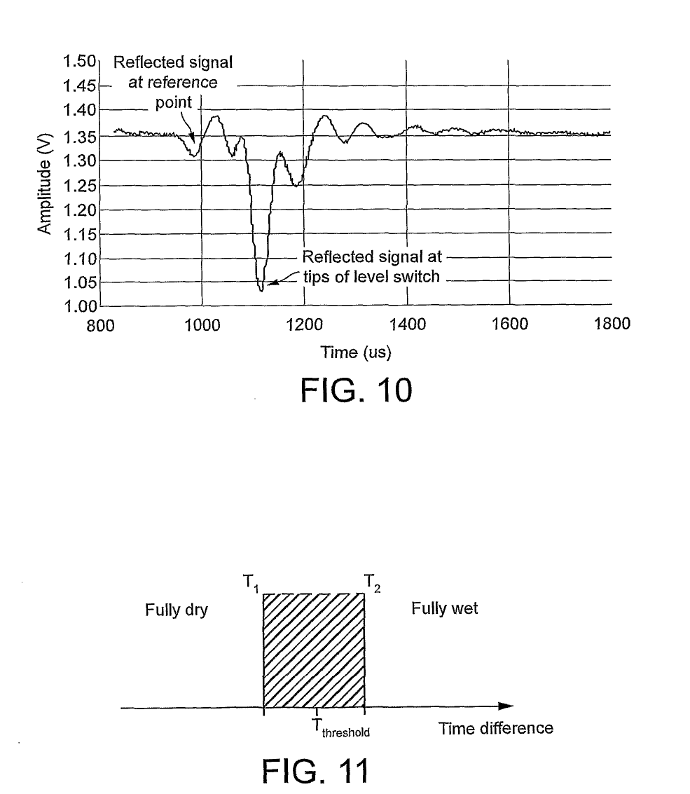

Referring now to FIGS. 8, 9 & 10, these show the signal traces of the sensor in air, water, and vegetable oil respectively. The time difference between vegetable oil and air is 20 μs and between air and water is 454 μs.

When compared with the two-tine example above, the two sensors exhibit the same performance in air/oil environments but in air/water the three-tine example shows a marked increase in time difference because of the differences in transmission line structure.

In both examples, when the sensors are operating with highly conductive liquids such as is water, a large positive reflection signal is generated by the liquid shorting the transmission line. The time interval between the positive peak and the negative peak can also be used to detect a wet condition of the sensor when a conductive medium is present. The time interval between the positive peak in water and the negative peak in air are 44 μs for the two-tine sensor and 30 μs for the three-tine sensor.

It should also be appreciated that the length of the side tines 35 of the three-tine sensor can be adjusted so as to change the point at which the sensor indicates a change in the wet/dry condition. This is a particular advantage of the three-tine over the two-tine sensor.

Whilst the examples herein have been described with reference to determining liquid levels in air, those skilled in the art will readily appreciate that the method and apparatus described herein can equally be applied to the determination of interface levels between materials (particularly liquids) of different permittivity. By way of example only, the method and apparatus could be applied to detecting the level of an interface between oil and water.

Thus the present invention provides a level sensor, and more particularly a level switch, which can operate in high temperature environments; can be mounted effectively on any length of extension tube; and has a very simple, non-toxic sensing section.

1. A method of determining when an interface between a first fluid of a first permittivity and a second fluid of a second permittivity is at a defined level, said method comprising: providing an electromagnetic transmission line having an outer end; causing an electromagnetic pulse to be propagated along and reflected back along said transmission line by a time domain reflectometry (TDR) technique; and detecting an interval between an initial time reference and the time of receipt of a reflected pulse, said method being characterized in that in includes:
mounting said transmission line at said defined level; and
assessing only whether said transmission line is in said first fluid or said second fluid from an observation of a time interval between said initial time reference and receipt of a pulse reflected from said outer end.

2. A method as claimed in claim 1 wherein said transmission line extends from a housing, said method further including establishing said initial reference time by causing a sudden change of impedance of said transmission line within said housing or within a connector fixed to said housing.

3. A method as claimed in claim 1 further comprising mounting said transmission line on an extension tube.

4. A method as claimed in claim 1 when applied to the determination of a level of liquid having air there-above.

5. A method as claimed in claim 1 when applied to the determination of a level between two liquids, each liquid having a different permittivity.

6. A method as claimed in claim 1 when applied to the determination of a level of flowable solids such as pellets and powders, with air there-above.

7. A method as claimed in claim 1 when applied to the determination of a level of a conductive liquid wherein the step of assessing whether said transmission line is in said conductive fluid includes the step of looking for a positive reflection signal generated by the liquid shorting said transmission line.

8. A level sensor operable to determine when the interface between a first fluid of a first permittivity and a second fluid of a second permittivity is at a defined level, said sensor including an electromagnetic transmission line having an outer end; an electromagnetic pulse generator operable to cause an electromagnetic pulse to be propagated along and reflected back along said transmission line by a time domain reflectometry (TDR) technique; and a detection facility operable to detect a time interval between an initial time reference and the time of receipt of a reflected pulse, said sensor being characterized in that:
in use, said transmission line is mounted at said defined level; and
said detection facility is operable to assess only whether said transmission line is in said first fluid or in said second fluid from an observation of a time interval between said initial time reference and receipt of a pulse reflected from said outer end.

9. A level sensor as claimed in claim 8 including an impedance step-change to generate said initial time reference.

10. A level sensor as claimed in claim 9 wherein said sensor is formed, in part, by a housing, said impedance step-change being formed within said housing or within a connector fixed to said housing.

11. A level sensor as claimed in claim 8 wherein said transmission line is defined by the tines of a fork assembly.

12. A level sensor as claimed in claim 11 wherein said fork assembly includes two tines.

13. A level sensor as claimed in claim 11 wherein said fork assembly includes three tines.

14. A level sensor as claimed in claim 12 wherein said tines are coated in a thin plastics layer.

15. A level sensor as claimed in claim 11 wherein at least one of said tines includes insulation about a root thereof.

16. A level sensor as claimed in claim 10 wherein said housing is formed from stainless steel.

17. A level sensor as claimed in claim 16 wherein said transmission line is located within said housing by plastics or ceramic insulating material.

18. A level sensor as claimed in claim 17 wherein said insulating material comprises PEEK.

19. A level sensor as claimed in claim 17 wherein one or more seals are provided between said insulating material and said housing.
